(19) United States
(12) Patent Application Publication
(10) Pub. No.: US 2008/0071586 A1
(43) Pub. Date: Mar. 20, 2008

(54) Computerized locus investigation system

(76) Inventor: Andrew J. Logan, Amesbury, MA (US)

Correspondence Address: LAHIVE & COCKFIELD, LLP, ONE POST OFFICE SQUARE, BOSTON, MA, 02109-2127, US

(21) Appl. No.: 11/986,765

(22) Filed: Nov. 26, 2007

Related U.S. Application Data
(63) Continuation of application No. 10/328,783, filed on Dec. 24, 2002.
(60) Provisional application No. 60/344,987, filed on Dec. 31, 2001.

(51) Int. Cl. G06Q 40/00; G06F 17/30; G06F 17/40

(52) U.S. Cl. 705/4

(57) ABSTRACT

A computerized locus investigation system for motor vehicles claims adjusters comprises an Internet-accessible database of photographs of street intersections and other potential motor vehicle accident sites (including intersections of any type of private or public ways accessible to motor vehicles), retrievable by queries specifying the intersecting streets or ways of interest. The database is comprised of images photographed using a digital still camera having voice recording means, for use by the photographer to tag each image with identifying geographical address information. Said voice-recorded address information is thereafter employed to provide each image file with a filename and textual description containing elements of the voiced address information.

### RELATED APPLICATION

This patent application is a continuation application of, and claims the benefit of, U.S. patent application Ser. No. 10/328,783 filed on Dec. 24, 2002, entitled “COMPUTERIZED LOCUS INVESTIGATION SYSTEM FOR MOTOR VEHICLE CLAIMS ADJUSTERS,” which claimed priority to and the benefit of U.S. Provisional Application Ser. No. 60/344,987 filed on Dec. 31, 2001. The disclosures of the above-identified documents are hereby incorporated herein by reference.

### FIELD OF THE INVENTION

The present invention concerns the motor vehicle claims industry, and more particularly a system and method for providing claims adjusters engaged in resolving claims arising from motor vehicle accidents with an immediately accessible access, over a network connection such as the Internet, to a computerized data base of photographs of roadway intersections, and other potential roadway accident sites, for use in lieu of custom locus investigations.

### BACKGROUND OF THE INVENTION

Insurance industry statistics report that there are over 35 million automobile accidents in the United States per year, and that the insurance “claims industry” expends in excess of $100 billion per year on personal injury settlements, property damage settlements, and claims adjusting expenses, all relating to automobile accidents. In particular, the insurance industry reportedly spends approximately $20 billion a year investigating accident-related claims, including some $2 billion specifically to investigate the intersection characteristics pertinent to particular accidents.

Insurance companies that participate in auto coverage insurance generally maintain internal claims units that typically employ full time investigators, or contract with independent adjusters, for the investigation of accident sites. When accident site information appears central to resolving responsibility for an accident, an employee-adjuster, or a hired investigator-adjuster, to resolving responsibility for an accident, an employee-adjuster, or a hired investigator-adjuster, drives to the site of the accident, and photographs the scene. Lengthy delays, typically days and often weeks, are generally encountered for the processing of the resulting photographs (and the receipt of investigator reports), and current prices for the provision of accident site photographs, and a short report, are in the range of $200 to $400 per assignment.

The investigation of motor vehicle accidents is thus a notoriously time-consuming, time-sensitive and expensive process, notwithstanding the industry-recognized direct relationship between delays in resolving claims and increasing indemnity costs of accident claims: The industry is constantly looking for ways to reduce both the cost and the time it takes to investigate and evaluate motor vehicle accident responsibility, however the industry has developed no practicable means to reduce the delays and costs associated with investigating motor vehicle accidents that are dependent on the geometries of the accident site, such as an intersection of streets.

The present invention addresses the need to provide claims adjusters with an inexpensive, yet immediately available source of pictorial information regarding automobile accident sites, including but not limited to street intersections. (As used herein, the term “street” encompasses roads, driveways and other public and private ways accessible to motor vehicles).

### SUMMARY OF THE INVENTION

The present invention is a system and method that provides the insurance industry, and specifically the motor vehicle claims sector of the insurance industry, with instant internet access to an online database of digital photographs of street intersections. The ability of insurance claims adjusters to access these photographs at will, and very inexpensively, greatly enhances the ability of individual adjusters to make a prompt assessment of motor vehicle accident responsibility, thereby enabling insurers to reduce their claims adjusting costs significantly, and to minimize claim losses (indemnity payments), while substantially increasing staff productivity.

A principal advantage of the present invention is that it enables significantly faster determinations of responsibility by claims adjusters. Faster processing of claims results in the lessening (and in many cases the elimination) of expenses such as motor vehicle storage charges, unnecessary medical treatment, and vehicle rental expense. Also, prompt and well-informed decisions by claims adjusters, based on a solid pictorial understanding of the accident site, greatly improves consumer satisfaction with the claims adjusting process, minimizing the litigation of claims and the participation of attorneys in the claims process, resulting in substantial cost reductions.

In addition, greater accuracy and efficiency in claims adjusting decisions, made possible by the present invention, result also in substantial savings from lower claim payments. Industry experts concur that the indemnity value of claims arising from motor vehicle accidents, and particularly personal injury claims, depend importantly on the claimant's perception of the quality of service provided by the insurer. In particular, the time taken by the claims adjuster to resolve a claim is widely recognized to have a major impact on claim indemnity value, and process inefficiencies therefore have a major, adverse impact on indemnity value. Simply put, unnecessary delays in the claim resolution process increase the costs in loss adjustment and indemnity expenses. The present invention, by substantially reducing the time required for claim adjustment decision-making, enables insurers to realize large savings in reduced direct costs, reduced staff time per claim resolution, and lowered indemnity payments.

Aspects of the present invention include procedures employed for the creation of a data base of photographs of motor vehicle accident sites, including photographs of street intersections and, preferably, also of other roadway sites that are potential motor vehicle accident sites, including mall and stadium entrances and driveways of public facilities such as restaurants, schools and governmental offices. Other aspects of the invention concern the presentation of said data base to users, preferably via network access over a public-access network such as the Internet.

The commercial feasibility of an intersection photograph database service according to the invention depends importantly on the economics of the development of the database. Inventive aspects of the present invention therefore concern the methods developed to build an intersection photographs database in a manner that is more cost and time efficient than any presently known photo gathering method used for comparable applications.

Over the last ten to fifteen years a number of systems have been developed for the gathering of photographic images of roadway features, notably for use in navigation systems to be marketed to the driving public. Typically such photo gathering systems and methods rely upon highly sophisticated devices including GPS devices. In surprising contrast to these prior art photo gathering methods, it has been determined that the most efficient procedure for gathering intersection photographs, and ancillary intersection identification information, for use in developing an intersection photographs data base specifically suited for the use of automobile claims adjusters, is to employ and train photographers, equipped with a digital camera that comprises means for recording brief audio messages, to take a still digital image of the intersection from each street view and tag each image with a brief identification message, and then have the captured images and audio messages efficiently processed in a separate “labeling” procedure, for uploading into the data base. It has thus been found that a trained photographer using this method may photograph and tag up to 500 intersection views in a single day.

### DESCRIPTION OF A PREFERRED EMBODIMENT

Personal injury and property damage claims that result from motor vehicle accidents are generally administered by the claims offices of property casualty insurance companies (and, to a lesser extent, by comparable offices maintained by large self-insurers, governmental agencies, and the like). These claims offices are typically divided into several areas of concentration, such as the Bodily Injury (or BI) department, the Property Damage (PD) department, the Subrogation department, and, in “no fault” states, a so-called “PIP” department. Of these four general departments of an insurance company claims office, the PD or Property Damage department is often hectic and contentious in atmosphere, as insurance company adjusters are required to deal on a daily basis with angry or frustrated insureds (“first party coverage”) or angry or frustrated claimants (“third party coverage”), all of whom seek from the adjuster a favorable decision involving the prompt payment of insurance company funds, whether for repair of an automobile, storage fee payments, replacement car rental, or waiver of deductible amounts.

The urgency with which demands are pressed onto adjusters makes the PD department the claims office group requiring the quickest action, although the claims adjuster making the claims decisions usually has little direct information regarding the basis for any claim other than what the insured and/or the claimant have submitted to the company orally or in writing, information which is often biased or inaccurate. Where a police officer was involved and has filed a report, it commonly takes a week or more for a copy of the report to be received in the mail by the claims office requesting it. Where the collision giving rise to a claim was serious, the other three departments of the claims office, Personal Injury, Subrogation, and “No Fault” may also each be involved.

In this administrative context, the decision whether to dispatch a company employee, or the employee of an independent adjusting company, to the accident site for a “locus investigation” and the taking of photographs of the site, is usually based on the perceived size of the claim and whether liability issues have or could be raised by the facts as reported by the insured, the claimant, or, perhaps, the police. Since the ordering of a locus investigation always constitutes the incurring of a discretionary “cost”, the insurance industry has never adopted policies calling for the ordering of a locus investigation for every single claim. In particular, locus investigations are generally not ordered in connection with the handling of the classic “fender bender” collisions that occur thousands of times a day across the country, and that daily involve hundreds of insurance companies in every state.

The present invention enables a fundamental change and improvement in the handling of claims arising from motor vehicle accidents, and particularly in the administration and resolution of small value claims, because it makes possible adjuster access to accident site photography in every case, even the smallest, instantly and at a fraction of the cost of conventional locus investigations.

With immediate access to accident site photographs, including photographs representing every orientation at the site, the Property Damage adjuster is now able to make much quicker and more accurate liability decisions (that is, whether or not to pay the claim for the damage to the vehicle which would depend on liability issues (third party) or coverage and liability issues (first party-limited collision coverage), whether or not to waive a deductible, whether or not to authorize a rental vehicle, whether or not to authorize removal of a vehicle from a storage lot.

In the past, and to the present day, the ordering of a locus investigation has been considered throughout the motor vehicle claims industry as a costly procedure, invariably requiring a substantial expenditure in time and out of pocket costs, and accordingly as a procedure that could not be justified in the resolution of smaller claims. With the present invention, the locus investigation is transmuted from a cost into an immediately available, inexpensive asset for the resolution of even the smallest claim. From a “cost” the locus investigation has been turned into a “net savings” tool for the claims industry: for those claims in which a locus investigation would have been ordered in any event, it sharply reduces the “time to resolution” factor that is a principal factor in the indemnity value of motor vehicle claims. For smaller claims, for which no locus investigation is ordered under current industry practice, use of the system of the invention enables a much better-informed resolution of claims (demonstrable to insured and/or claimants), resulting in greater satisfaction with the claim adjustment process on the part of insureds and claimants, again resulting in reduced indemnity values payable by the insurance company.

In addition to the Property Damage department of the insurance company, the Subrogation department also benefits substantially from the use of the system of the invention. Traditionally considered the “graveyard” of the claims office, the Subrogation department requires its personnel to engage daily in often frustrating and contentious arguments with their counterparts from another insurance company, regarding the relative percentage of liability from a given collision that should be assigned to their respective companies. Under current practice, with each side armed only with the minimal and often conflicting site information provided in the reports of the drivers involved in the collision, the two opposing “subro” adjusters often agree to a 50-50 split of liability, for lack of accurate and uncontested site information.

With the aid of the intersection photograph database of the present invention, a subrogation adjuster is in a much better position to assert a persuasive liability argument, resulting in either paying less or recovering more than would otherwise be possible, when that argument is supported by favorable accident site photography.

With respect to personal injury claims, the Bodily Injury department of the insurance company may opt, depending on the seriousness of the reported injuries, to dispatch an employee (or an independent adjuster or investigator) to perform a thorough investigation, including the interviewing of witnesses in addition to a “locus investigation”. However the great bulk of BI claims involve so-called “soft tissue” injuries that often have a subjective component (e.g., neck or back pain) as opposed to so-called “hard” injuries, such as broken bones, that are readily subject to objective verification. Under current insurance company practice, locus investigations are generally not routinely ordered for soft tissue injuries, in view of the “costs” of such investigations. As for property damage claims, however, access to the accident site photographic data base of the present invention provides a BI adjuster handling either a soft tissue or a hard injury claim with a clear understanding of the accident site that enables a more accurate and confident claim resolution.

Data Gathering:

The street intersection data employed by a system according to the invention comprises photographs of intersections of streets (and other motor vehicle access ways), matched to identification data that, for each photograph in the database, identifies the intersection, the street or way from which the photograph of the intersection was taken, and the compass orientation of the photograph (i.e., North, South, East or West).

Preferably the photographs in the data base, and their respective identification information, have been gathered by photographers (preferably organized in teams for the rapid coverage of a town or other target area), each of which has been equipped with a digital camera that also comprises an internal voice recorder capable of recording a brief audio message in association with the taking of each digital image. It has been determined that the use of a digital still camera, that also has the capacity to record, in association with each photograph, a brief audio message that identifies the street and orientation of the photograph, results in a remarkably efficient and low cost method for the gathering of the photographic data required to compile an accident site photographic data base.

Currently a camera suitable for this purpose is the Sony Mavica digital still camera, Model MVOFD 92, marketed by Sony Electronics Inc., 1Sony Drive, Park Ridge, N.J. 07656. A digital camera such as the Sony Mavica Model MVC-FD92 permits a trained photographer to capture 250 to 500 images per day, and to provide, for each image, a brief (5 seconds or so) audio message that is recorded on the camera's storage medium in association with each image. The Sony Mavica camera also provides, on each image, an identification of the date and time when the image was recorded. The Sony Mavica camera employs, as a data storage medium for recording both image data and audio data, standard 3.5″ “floppy disks”, of the 2HD (1.44MB) type, formatted in MS-DOS format (512 bytes by 18 sectors); using a 640×480 pixel resolution setting (which is suitable for the present application), some 11 or 12 images, and associated messages, may be captured on each disk. This camera may also employ Sony Memory Stick recording media, that have a substantially greater capacity than floppy disks. Some 34 images (and messages) may be recorded on a single 8 MB Memory Stick device, and over 540 images (and messages) on 128 MB Memory Stick devices.

Photographers are provided with assignments identifying the intersections and other potential accident sites that each is to photograph. Arriving at a site, the photographer takes a position on one of the intersecting roads approximately 75 to 100 feet from the center of the intersection, and preferably near the center of the roadway, in order to present the camera with a “driver's view” of the intersection, which is the view generally considered most helpful to an insurance claims adjuster. The photographer will strive to frame the photo so as to include within the captured image the maximum information pertinent to a claims adjuster in determining liability in the event of an accident. Such relevant information can take many forms but would normally include such traffic control signage as signal lights, stop signs, yield signs, speed limit signs, and any restrictions painted on the roadway, as well as any natural or man-made obstructions to view, sharp bends in the road, and the like.

Upon framing the image and snapping the picture (then holding the camera motionless for a moment if required by the camera model prior to capturing the image), a photographer using the Sony Mavica digital camera has approximately 5 seconds to record an audio message that will serve to provide the identification of the image. (When circumstances require, longer messages may also be recorded). Preferably, the system developer has provided staff photographers with a set procedure for dictating this image identification information. Referred to herein as “the Call,” this image identification information preferably comprises:

The direction from which the picture was taken;

The complete name of the roadway;

The complete name of the intersecting roadway.

For example: “North on Main Street at Elm Street.

The photographer then proceeds to take an image-taking position on another street forming part of the same intersection, and repeats the process described above.

The typical intersection is either a T type intersection that requires the taking of 3 images of a +“cross” type intersection that requires 4 images. However there are other types of intersections, and several of these other types will require not only the taking of additional images but also a different “Call”, in order that a comprehensive and accurate pictorial representation of the entire intersection (including a view from each street and orientation a driver might take) may be made available to a claims adjuster having no familiarity with the site. For this purpose the system developer should develop a system of “calls” sufficient to cover substantially all intersection types that a photographer might encounter.

In some instances, depending on the complexity and the configuration of the intersection or other roadway site of interest, the photographer may determine that, to properly image the site, it is necessary to take several photographs from the same direction, such as four or five separate views all looking North all taken from the same street or road. Typical circumstances for such a decision include roadways that are very wide, or divided, requiring both long distance views and closer shots that clearly image small but pertinent features such as directional signs or restrictions painted on the roadway at the entrance to the intersection. There may be a number of oddly spaced traffic signs, which cannot all be clearly imaged in one or two photographs, or the number of travel lanes may increase (say, to allow for a turning lane) or decrease, in a manner not visible from a perspective view.

Clearly a calling system must be employed that will permit the photographer to make brief calls, and yet enable the labeler to distinguish the several photographs taken from the same general orientation on the same street. One technique is to have the photographer identify the first such photograph, with the longest view, with the pertinent compass point, say “n+route1+route114”, indicating a North facing view taken on route 1 towards its intersection with route 114. For the next view or views, on the same street with the same general orientation, the photographer's call may be “same as last call” [meaning “also North”]+route1+route114”. In the ensuing labeling operation, a labeler will interpret the second and other calls, citing “same as last call”, as referring to views having the same compass orientation as the earlier call.

When a data storage disk or Memory Stick has been filled, the photographer removes the disk or other device from the camera and writes appropriate disk identification information on the label affixed to each disk. Such information may for example include, for each disk, a sequential number identifying the disk, the name of the city or town and state, the correct spelling of all streets “called” on the disk, and the map quadrant on which the imaged intersection or intersections are located, and a code identifying the photographer. The information thus written on each disk assists in-office “labelers”, responsible for entering the street identification data into the database, to enter the correct street names, a critical consideration for users seeking to access intersection images; also, it permits retrieval of the original photograph on a disk, which contains date and time information that may become important in circumstances such as authentication of the image as trial evidence.

The Labeling Procedure:

The photographs and audio messages created by the photographers, as described above, are transmitted to an office staff for processing, as needed to prepare the images and identification information for retrievable storage on a user accessible database. The labeling staff is responsible for processing the image and audio information captured by staff photographers, and converting such information into a form suitable for uploading to the database server that users of the system will access to retrieve intersection photographs. This labeling tasks include converting the photographer's oral “call” identification of the location and orientation of each image into a searchable text description, editing the identification for accuracy, and creating such file associations as are needed to insure that, upon upload to the data base server, all photographs (and associated textual identifications) concerning a specific roadway site (which may easily comprise 4 to 6 or more images) are readily and collectively retrievable by a user who selects that roadway site for display.

Various conventional means are available to transmit the data captured by the photographers to the labeling operation. These means include physical delivery of the disks or other storage media containing the captured data to the office staff, the wireless transfer of the captured information from the site of the imaging procedure, or computer-to-computer transfer over a network connection. The latter data transfer method is particularly useful where the sites being photographed are distant from the location of the image labeling operation: the photographer simply places the data carrying recording media (diskette, Memory Stick, etc.) in a computer adapted to receive such media, and electronically transfers its data files over the Internet (or any other suitable network) to a computer accessible to the labeling staff. Sony Memory Stick recording media are equipped with USB connectors, making it a simple process to transfer data recorded on such media from and to any network-connected computer, as email attachments or using other file transfer modes.

The processing in the “labeling operation” of the image and audio data captured and created by the photographer teams, in preparation for uploading onto the user accessible database, may readily be accomplished by following conventional procedures for associating searchable textual tags to image files, and for uploading the resulting image and associated identification data onto a database intended for access by subscribers to a network-based database service.

Digital cameras such as the Sony Mavica camera generally store images on their recording media in formats (such as jpeg for images and mpeg for sound files) that are supported by software programs in common use, to facilitate access to the images (audio clips, etc.) using standard software products. The Sony Mavica camera thus offers several formatting options for recording image and audio data, including jpeg format for images, and mpeg format for the audio clips that contain the photographers' spoken location and orientation information. Both the jpeg and the mpeg formats are widely used and “supported” formats, and files recorded in these formats may readily be opened using a variety of graphic software programs (for jpeg) or multimedia software programs (for mpeg). It is accordingly a simple task to design procedures for manipulating these image and audio files as needed to create and maintain a searchable database of roadway site photographs from the jpeg and mpeg files.

For the labeling task it is necessary to provide labeler staff with software means to access the image and audio files created by each photographer, so that the labeler may display each image in a given series, one after the other, while simultaneously listening to a replay of the “call” associated with each image, in order to tag the image with a textual label that accurately identifies the street name and the orientation of the image, in addition to affixing to the image a suitable code for identifying the specific intersection (or other roadway location) to which the image pertains.

As received by the labeling staff, whether by physical delivery, electronic transfer over a network connection or otherwise, the image and audio data consists of a collection of jpeg image files, one per photograph, and mpeg audio clip files, generally also one audio file per associated image file. As noted above the task of the labeler is to tag each image with a searchable textual description including the street name and the orientation of the photograph, and then to upload the resulting file to a user-accessible database. This task could well be performed, albeit somewhat painstakingly, using no more than the software resources provided by a typical personal computer loaded with the standard off-the-shelf Microsoft Windows application products commonly incorporated into “home use” versions of current model personal computers.

Thus such commonly incorporated software applications as Microsoft Works, Microsoft Paint and Microsoft Windows Media Player collectively comprise all of the functions needed for the labeling tasks, including the creation of a searchable database. It is more practical and efficient, however, for the developer of a system according to the present invention to develop a simple software program to assist the labeler, by creating for the labeler a custom user interface that will provide the labeler, on a single desktop, with access to the files and functions needed in order to efficiently label each image and to upload the labeled images to a data base holding server.

In particular, simple software applications may readily be developed, for use on Windows-based personal computers or for use on other computers, for use by office personnel of the system provider to easily process the photographer-created image and audio files for uploading onto the user-accessible data base. For example, a simple VBA (Visual Basic for Applications) “labeling application” may readily developed to assist staff (herein called “labelers”) who are assigned the task of labeling the photographed images prior to their being uploaded onto the data base server. Such an application would create a user interface, presenting labelers with a desktop from which to open and display jpeg image files, and open the associated mpeg audio files containing a message identifying the locus and orientation of the image; in a preferred embodiment, said labeler user interface would comprise a display screen (or “picture control”) for displaying at will any photograph stored in jpeg format on a diskette supplied by a staff photographer, and means for simultaneously opening the associated audio message, enabling the labeler to attach to the image a text label containing the locus information recorded by the photographer. In the alternative said labeling application could readily be designed to support a voice recognition application, enabling the photographer's audio message to be automatically converted into text viewable on a desktop window adjoining the image viewing window, for editing as needed by the labeler.

Using a simple software application like that described above, the labeler upon insertion of a diskette containing image and audio data captured with a camera such as the Sony Mavica camera, and opening the folders stored in the diskette, will be presented, in a desktop window, with a list of jpeg files each of which comprises a high resolution photographed image, and a list of the associated set of mpeg format files that comprise the audio clips associated with each image. At this point these files carry filenames assigned by the camera that bear no relation to their subject matter. However, filenames may readily be changed at will. Therefore, renaming each jpeg format file that contains a photographed image, with a name that now references specifically the locus of the imaged site, will enable retrieval of the image in response to the entry, in search queries, of matching geographical address identifiers. By opening the audio mpeg file associated with each jpeg format image file, the labeler initiates a replay of the photographer's voiced call, and is thereby provided with the locus information necessary both to label the description of the image that will appear on the user's screen, and also to assign to that image a filename directly referencing the locus of the imaged site.

To rename the jpeg format image file, employing conventional Microsoft Windows functions, the labeler “right clicks” the pertinent jpeg filename; thereby opening a list box of available actions including the “rename” function. Clicking the “rename” checkbox opens a text entry box within which the current name can be replaced, and the labeler inserts in this box a new filename, drawn directly from the photographer's recorded voice call, that sets forth the locus information pertinent to the particular image.

(Alternatively, in an enhanced embodiment employing currently available voice recognition software, and conventional programming, some or all of these labeler activities could be performed automatically. In particular the audio clips of the photographer's “calls” may be converted to text by voice recognition software, either for display for use by a labeler, or directly into a programmed file renaming function).

Thus a principal function of the image file labeling operation is to assign to each jpeg file, that contains a photographed image of a street intersection, a file name that specifically and uniquely identifies that image as pertaining to the photographed site. For this purpose it has been found that the consistent use of a naming convention based directly on the photographer's call is highly efficient, and results in the definition of file names that permit accurate searches of intersection photographs.

Thus a preferred file designation method is to assign to each image file a name that contains, in sequence, a letter designating the orientation of the photograph, then the name of the street from which the image was taken, and lastly the name of the intersecting street. Thus the file name for an image of a North-facing view taken on Elm Street and facing its intersection with Main Street, would be “n+elm+main.jpeg”. Using this system, a labeler can very quickly change the file name of the images, from the generic and sequential file names assigned by the camera software, to a unique file name taken directly from the photographer's voice call, which file name also corresponds to a thumbnail description of the photographed image.

Where images are to be stored on the system database in folders comprising images segregated by city or town, the use of file names that consist of two street names in a set sequence results in the setting of a unique, accurately descriptive name for each image file.

It is highly desirable, to minimize errors and to increase the efficiency of the labeling operation, for the system developer to have developed a set of “Call” procedures for handling the identification of streets and orientations where the intersection or other potential roadway accident sites is atypical, that is, other than a conventional T type or +type intersection. There are a number of atypical sites for which it is desirable to have developed systematic “call” procedures, to minimize if not eliminate occasions for error or confusion between the photographer's “call” identifications and the labeler's interpretation of those calls.

In practice it has been discovered that road and street intersections that have an unconventional geometry can generally be handled through a deconstruction of the site into a group of adjoining T type or +“cross” type intersections. This technique works well with a large variety of intersection variants, including what may be termed “loops”, where a single street intersects in two places with another street (think of a straight line intersected at two points by an arc), and also with “staggers”, where (as in a tree with two opposing branches separated by a gap) opposing sides of the intersecting street are somewhat separated. Where photographers and labelers have been trained to use consistently a uniform set of calling conventions for these atypical intersections, these sites are readily dealt with successfully.

One method for dealing with the “loop” intersection is simply to add, in the “call” a brief extension to the name of the looping street, to distinguish its first intersection with the other street from its second such intersection. Thus, “n+Elm West+Main” versus “n+Elm East+Main”, to distinguish the Westerly loop intersection from its Easterly mate, when in each case the photograph is taken on Elm Street facing North towards an intersection with Main Street.

Similar conventions are readily devised for other atypical intersections: dealing with a broad, multi-lane divided highway, a distinction can be made for photographs taken on, say, the Southbound lanes of Highway 140, from those taken, with the same orientation, from the Northbound lanes of Highway 140, by adding the extension “Southbound,” or “Northbound,” (as appropriate) to the identification “Highway 140.”

Besides intersections that have an unconventional geometry, other atypical intersections have street names that change from one side of the intersection to the other, or between opposing sides of the street. Here also, the adoption and consistent use of simple conventions resolves the photograph identification problem unambiguously, in a manner that ensures that a user will have access to all pertinent photos even if the user querying the database is unaware of the street's change of name at this intersection.

A suggested method for dealing with the “change of street name” abnormality, referred to herein as “fudging the call”, is basically to photograph and process each name-changing street twice, with duplicate photos captioned with the two different names of the name-hanging street. Thus, for a standard 4 way intersection involving a street that changes its name at this intersection, say from Elm to Oak, on opposing sides of its intersection with (North to South) Main Street, the following suggested procedure avoids any ambiguities:: The photographer takes two photographs from each position, “calling” once from Main looking North: “north on Main at Elm, Elm is on the right, Oak is on the Left”, then, from the same position, “north on Main at Oak, Oak is on the left, Elm is on the right.” From Elm/Oak street, when on the Oak Street side, the call is, first, “East on Oak at Main^{W}, then, from the same position, “fudging the call, East on Elm at Main,” and similarly from the Elm Street side of Elm/Oak street. Where photographer and labeler have been trained to use such a code, proper labeling of the uploaded photograph results and ensures no loss of images on the part of a user.

On occasion there will be a need, in order to accurately image all pertinent features of an intersection or other potential accident site, to take several different images from the same general orientation on the same street; in such cases, the usual definition of image orientation using compass points (N, W, E, and S) will not be adequate to distinguish the several images having the same general orientation. One method for distinguishing several images that share a common orientation is to assign the compass point designation, say North, to the first such image, and in the “calls” concerning the ensuing images to use orientation designations using the letters that alphabetically follow the original compass point designation: thus the next image would be given the designation “o”, then “p”, then “q”.

In the course of the labeling operation it is important that the use of short-hand techniques, like those described immediately above, to distinguish among a series of images taken on the same street from the same general orientation, be replaced by textual descriptions that accurately inform data base users of the relative orientations of the several photographs.

Uploading:

Upon completing the labeling of a series of images, the labeler proceeds to upload the resulting files to a database, typically but not necessarily located on a dedicated server computer. When successfully uploaded to this database, the images are immediately made available to all subscribers of the system. The labeling operation and the uploading operation are described as separate, sequential operations that may be carried out by different personnel at different times and places. However these two operations may be combined into a labeling and uploading operation, to be carried out by the same labeler in direct sequence. In the preferred embodiment described herein there are provided two opportunities for a labeler to edit image descriptions, first in an initial labeling operation, carried out locally and thus independently of the system database, and optionally also upon accessing the system website through functions administered by the database management software.

In a preferred embodiment of the invention the uploading operation is initiated by accessing a “Backend Database Management” area of the system website, by typing an appropriate URL address. On accessing the site, a screen is displayed that requests the labeler to submit a recognized user name and password in order to proceed further. An “Admin Main” menu then opens and presents a selection of options, in the form of buttons or as selectable entries in a combo box, including an “Add new entry” selection. Clicking on “Add new entry” opens a new screen for the labeler, containing a drop down list box for entering the pertinent state; submission of a state opens a new drop down list box, which requests the selection of a city or town, from a pre-set list of all cities and towns for which coverage has been or is in the process of being provided.

At this point a “browser” button with an associated text box opens, enabling the labeler to locate the files to be uploaded, whether on an accessory drive such as a 3.5″ floppy disk drive, a CD drive, a zip drive or the like, or in the system hard drive, to which the files to be uploaded have been saved following a transfer as described above. There then appears, in a file listing box, a listing in alphabetical order of the file names assigned to each photographed image. Selection of any listed file (effectuated by double clicking thereon) causes the selected file to appear in a new box, subject to the button controls “Upload this file” or “Cancel”; at this point the selected file has not been uploaded, but merely selected for review and possible text editing prior to being uploaded to the system data base. Clicking the “Upload this file” button causes the image stored in the selected file to be displayed, in a window on a screen that also contains a “Description” box that displays the current image identification text associated with the displayed photograph. This text, unless edited by the labeler prior to uploading of the file to the data base, is precisely the text that will be displayed to a subscriber user having access to the “front end” of the data base.

Accordingly the labeler employs this opportunity to make any needed changes to the image identification; in particular this step should be used by the labeler to insure that any unusual comments or instructions given by the photographer in the course of the “call” have been properly carried out. For example, in instances where local circumstances called for several photographs to be taken from the same general orientation from a single street, the labeler at this point should take appropriate actions, in editing the description of each image, to insure that its orientation and relationship to other images in the same series has been accurately described in the text that is to be displayed in association with the image on the data base.

It should be understood that a commercial system according to the present invention will preferably make available to insurance claims adjusters photographs of many types of roadways sites, other than classic street intersections, that are susceptible to potential motor vehicle accidents giving rise to liability claims for personal injury and property damage. Accordingly a locus investigation system according to the present invention could and should be extended to cover the photography of public and private ways that are accessible to motor vehicles, including shopping mall entrances and parking lots, entrances and parking lots of sports stadiums, airports, industrial parks, governmental buildings and complexes, and the like.

Preferably the website of the system provider will also make complementary services available to insurance customers. For example, the system provider may also provide an accident diagram product, whereby the claims adjuster user of the system may, in studying a particular claim, or in discussing that claim with a claimant, an insured or a witness, use “drag and drop” techniques to create and save accident scene diagrams that incorporate witness testimony regarding the location of the automobiles involved in the accident; “comment” boxes may preferably also be provided for inserting comments regarding any such diagrams.

The same or additional “Comment” text boxes are preferably also provided in order to permit adjuster users of the system of the invention ample space to type notes besides any one or more of the pictures, both in the course of an independent study of the images and importantly also in the course of conversations with an insured, a claimant or an opposing subrogation adjuster.

Many insurance companies have not yet provided all claims adjusters with access to the Internet network. For such companies the photograph database services of the present invention may be provided using conventional mail and courier services, upon receipt of a request by the system provider, by telephone, email, or any other suitable means, including storage of the photographs database on a storage medium such as CDs. While much inferior to instant Internet access, even ordinary mail service access to a intersection photographs database according to the present invention would still be superior, in time and cost savings, to the current practices of insurers.

In developing a system according to the present invention, it has been determined to be most practical to proceed in a manner that complements claims frequency. Thus, photo coverage of the most dangerous intersections of major cities is the highest priority, followed by other major urban intersections, then intersections on interstate routes, followed by all intersections, including driveways of heavily trafficked facilities such as shopping centers and strip malls, restaurants, schools, liquor stores, churches, and governmental offices.

Currently the methods found to be most effective in dispatching photographers to cover a target area has been to operate on foot in dense urban areas, while using cars, motorcycles or bicycles for photography in suburban areas where intersections are spaced further apart. Specially equipped vehicles, such as automobiles modified to carry one or a plurality of cameras, may also be employed, including vehicles equipped with voice activated cameras that may be activated by voice commands from a driver or passenger.

It likewise should be understood that the image labeling operation is not required to be conducted at a site remote from the photographed site. Photographers may readily be equipped with laptop computers or like means for editing image descriptions, and for uploading the resulting complete files to the data base server, using presently available means for the wireless transfer of computer files.

At times posted speed limit signs are close enough to the intersection to become a part of the photograph, and photographer staff should be instructed to include those signs when framing the picture of an intersection or other roadway site. Often times, however, no pertinent speed sign is sufficiently close to the selected site for inclusion in the image; it is accordingly desirable to expand the photograph data base to include the pertinent speed indicator nearest a photographed potential accident site.

It should be understood that the specific image-capturing means specifically described above are illustrative, and that other image and audio capture means may also be employed in the practice of the invention. In particular streaming video cameras and 360 degree cameras may also be employed to image potential accident sites, with suitable modifications of the labeling methods and practices also employed to take account of such other imaging methods.

The selection of a pricing method for use of the system of the invention by an insurer user is subject to the discretion of the system provider. One pricing model is to make access to the service free of charge, and to charge on a per-use basis. Alternatively, pricing may be on a subscription basis, with a set periodic charge for example scaled to the size of the client's staff. Preferably, users are first required to establish an account, and to provide appropriate credit references, in order to obtain password access to the system.

A provider of the photo database services of the invention may profitably provide ancillary services from the same website, such as road map information, weather information, and police reports.

The present invention is directed principally to the motor vehicle insurance claims industry. It will be readily appreciated that the invention may also be applied to advantage in related fields, for example including motor vehicle claims litigation and also “surcharge” hearings, concerning proceedings whereby, pursuant to insurance regulations under state law that require drivers determined to be culpable for certain accidents to incur insurance fee surcharges for ensuing years. The surcharge hearing allows a driver to contest an insurer's surcharge determination, and instant access to accident site photographs may provide significant assistance to the trier of fact in such proceedings. In general, all fact-finding procedures concerning motor vehicle accident claims, notably including settlement conferences between attorneys representing opposing parties, may benefit from instant access to accident site photographs as provided by a system according to the present invention.

We Claim:

1. A method for identifying street features, comprising:
acquiring data, the data including at least one photograph of a street;
associating the at least one photograph with a label following a pre-determined labeling protocol, the pre-determined labeling protocol including orientation information associated with the at least one photograph of the street; and
providing the data and the label to an entity, the entity storing the label associated with the data.

2. The method of claim 1, wherein the street is a road, a driveway, a public way or a private way accessible to motor vehicles.

3. The method of claim 1, wherein the at least one photograph is acquired on the street, between about 75 to about 100 feet from an intersection, proximal to a center of the street, by presenting a camera with a driver's view of the intersection and capturing an image.

4. The method of claim 1, wherein the at least one photograph includes traffic control signage.

5. The method of claim 4, wherein the traffic control signage comprises one or more of a signal light, a stop sign, a yield sign, a speed limit sign, or a restriction painted on the street.

6. The method of claim 1, wherein the at least one photograph includes natural or man-made obstructions to viewing the street.

7. The method of claim 1, wherein the entity stores the label as a searchable text description.

8. The method of claim 1, wherein the label is an audio label.

9. The method of claim 8 wherein the at least one photograph is taken using a digital camera that includes an audio label recording mechanism for recording the audio label in association with each photograph taken.

10. The method of claim 8, wherein the entity comprises a voice recognition software tool that translates the audio label into a searchable text description.

11. The method of claim 1, wherein the predetermined labeling protocol comprises:
an entry for a compass orientation from which the at least one photograph is acquired; and
an entry for a name of the street.

12. The method of claim 11, wherein the label contains, in sequence, a letter designating the compass orientation from which the at least one photograph is acquired and the name of the street.

13. The method of claim 11, wherein the label has a format of x+y, wherein x is a letter indicating the compass orientation from which the at least one photograph is acquired and y is one or more words indicating the name of the street.

14. The method of claim 11, further comprising an entry for a name of an intersecting street.

15. The method of claim 14, wherein the label contains, in sequence, a letter designating the compass orientation of the at least one photograph, the name of the street, and the name of the intersecting street.

16. The method of claim 14, wherein the label has a format of x+y+z, wherein x is a letter indicating the compass orientation of the at least one photograph, y is at least one word indicating the name of the street, and z is at least one word indicating the name of the intersecting street.

17. The method of claim 14, wherein the label further contains an extension to the name of the street when the street intersects with another street more than once.

18. The method of claim 11, wherein the label further contains an entry indicating traffic flow direction when the street is a multi-lane divided highway.

19. The method of claim 1, wherein the label is repeated for subsequent photographs of a same street.

20. The method of claim 1, further comprising creating a user searchable database and storing the at least one photograph associated with the labels therein.

21. The method of claim 20, wherein the at least one photograph is stored in the database in folders segregated by state, by city, or by town.

22. The method of claim 1, wherein the data is provided to the entity through a physical delivery of storage media, a wireless transfer of the data, or a computer-to-computer transfer of the data over a network connection.

23. The method of claim 1, further comprising:
acquiring two photographs of a single name-changing street; and
associating a different label to each photograph according to the predetermined labeling protocol.
